(19) United States
(12) Patent Application Publication
(10) Pub. No.: US 2026/0360086 A1
(43) Pub. Date: Nov. 12, 2026

(54) EVENT BASED UPDATE IN SCENE DESCRIPTION

(71) Applicant: InterDigital CE Patent Holdings, SAS, Paris (FR)

(72) Inventors: Sylvain Lelievre, Montgermont (FR); Pierrick Jouet, Rennes (FR); Patrice Hirtzlin, Betton (FR); Etienne Faivre d'Arcier, Saint Gonlay (FR); Loic Fontaine; Serge Defrance, Rennes (FR)

(21) Appl. No.: 19/131,812

(22) PCT Filed: Nov. 28, 2023
(86) PCT No.: PCT/EP2023/083262

§ 371 Date: May 21, 2025

(30) Foreign Application Priority Data
Dec. 15, 2022 (EP) 22306885.9

(51) Int. Cl. G06T 19/00

(52) U.S. Cl. CPC G06T 19/00

(57) ABSTRACT

Some embodiments of a method may include: obtaining scene description data for a three dimensional (3D) scene, wherein the scene description data includes: scene element information describing each of a plurality of scene elements in the scene, trigger information describing at least one trigger condition, and action information describing at least one action to perform on the first scene element of the plurality of scene elements, wherein the action information includes: a list of at least an update action, and update action information, wherein the update action information includes: a patch parameter, and in response to determining that: (i) a trigger condition of the at least one trigger condition has occurred and (ii) the action information indicates that the update action is to be performed, performing the update action to apply the patch parameter as update to the scene description data.

### CROSS-REFERENCE TO RELATED APPLICATIONS

The present application claims priority of European Patent Application Serial No. EP22306885, entitled “EVENT BASED UPDATE IN SCENE DESCRIPTION” and filed Dec. 15, 2022, which is incorporated herein by reference in its entirety.

### BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such scene description frameworks ensure that the timed media and the corresponding relevant virtual content are available at any time during the rendering of the application, such frameworks do not provide a description of how a user can interact with the scene objects at runtime for immersive XR experiences. Hence, there is no support of user specific XR experiences for consuming the immersive media.

### SUMMARY

A first example method in accordance with some embodiments may include: obtaining scene description data for a three dimensional (3D) scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least an update action, and update action information, wherein the update action information includes: a patch parameter; and in response to determining that: (i) a trigger condition of the at least one trigger condition has occurred and (ii) the action information indicates that the update action is to be performed, performing the update action to apply the patch parameter as an update to the scene description data.

For some embodiments of the first example method, determining that the trigger condition has occurred comprises a logical determination that the trigger condition has occurred.

For some embodiments of the first example method, determining that the trigger condition has occurred comprises determining that the trigger condition has produced a true result.

For some embodiments of the first example method, the patch parameter indicates one or more operations comprising one or more of add, remove, replace, move, and copy, and the one or more operations are applied to a JavaScript Object Notation (JSON) element of the scene description data.

For some embodiments of the first example method, the update action information further comprises a shared field, the shared field indicating a status of sharing with devices connected to the 3D scene.

Some embodiments of the first example method may further include in response to determining that the shared field indicates a true result, performing the update action on at least one device sharing the 3D scene.

Some embodiments of the first example method may further include in response to determining that the shared field indicates the true result, performing the update action on all devices sharing the 3D scene.

For some embodiments of the first example method, the update action information further comprises a place description field and a placedItems field, the place description field identifies a source of location information, the placedItems field is an array, and the placedlems array indicates patch operations that reference nodes to be placed at a given location.

For some embodiments of the first example method, the update action comprises setting a location of at least a scene element within the scene, and the at least scene element of the scene is referenced in the at least path operations from the placedItems field, and setting the location of the at least scene element uses the location information from the identified source.

For some embodiments of the first example method, the update action information further includes: a childOps array, the childOps array indicating patch operations that reference a node that is to be set as a child of an existing node in the scene description data; and a parents array, the parents array indicating nodes of where to add each new child referenced in the patch operations from the childOps array.

For some embodiments of the first example method, the scene description data further comprises behavior information.

For some embodiments of the first example method, each of the one or more operations comprises a set of operation parameters, and each set of operation parameters includes: an operation identifier, a path to a JavaScript Object Notation (JSON) element of the scene description data, and a value to apply.

For some embodiments of the first example method, the path is a JSON pointer referencing the first scene element.

For some embodiments of the first example method, each of the one or more operations comprises a set of operation parameters, and each set of operation parameters includes: an operation identifier, a path to a JavaScript Object Notation (JSON) element, and a source JSON element.

For some embodiments of the first example method, the path is a JSON pointer referencing the first scene element.

For some embodiments of the first example method, the patch parameter indicates a JavaScript Object Notation (JSON) patch to apply to the scene description data.

For some embodiments of the first example method, the patch parameter includes a location pointer to a JavaScript Object Notation (JSON) file comprising a JSON patch to apply to the scene description data.

A first example apparatus in accordance with some embodiments may include: a processor; and a non-transitory computer-readable medium storing instructions operative, when executed by the processor, to cause the apparatus to perform any one of the methods listed above.

A second example method in accordance with some embodiments may include: obtaining scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least a set action, and a set action information, wherein the set action information includes: a path, the path identifying the first scene element, and a value, the value indicating a new value for the first scene element; and in response to determining that: (i) a trigger condition of the at least one trigger condition has occurred and (ii) the action information indicates that the set action is to be performed, performing the set action to set a value associated with the first scene element to the new value for the first scene element.

For some embodiments of the second example method, determining that the trigger condition has occurred comprises a logical determination that the trigger condition has occurred.

For some embodiments of the second example method, determining that the trigger condition has occurred comprises determining that the trigger condition has produced a true result.

For some embodiments of the second example method, the path identifies a location of the first scene element within a scene tree.

For some embodiments of the second example method, setting the value associated with the first scene element sets the value associated with the first scene element to the new value.

For some embodiments of the second example method, the set action information further includes a shared field, the shared field indicating a status of sharing with devices connected to the 3D scene.

Some embodiments of the second example method may further include in response to determining that the shared field indicates a true result, performing the set action, of the at least one action, on at least one device sharing the 3D scene.

Some embodiments of the second example method may further include in response to determining that the shared field indicates the true result, performing the set action, of the at least one action, on all devices sharing the 3D scene.

For some embodiments of the second example method, the set action information further comprises a place description field, and the place description field identifies a source of location information.

For some embodiments of the second example method, the set action includes setting a location of the first scene element within the scene, and setting the location of the first scene element uses the location information from the identified source.

For some embodiments of the second example method, the path is a JavaScript Object Notation (JSON) pointer referencing the first scene element.

For some embodiments of the second example method, the path includes path information referencing the first scene element, and the path information corresponds to an Internet Engineering Task Force (IETF) standard.

For some embodiments of the second example method, the scene description data further includes behavior information.

A second example apparatus in accordance with some embodiments may include: a processor; and a non-transitory computer-readable medium storing instructions operative, when executed by the processor, to cause the apparatus to perform any one of the methods listed above.

A third example method in accordance with some embodiments may include: obtaining scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least an update action, and an update action information, wherein the update action information includes: a scene description patch; and in response to triggering execution of the update action, performing a first action, of the at least one action, on the scene description data.

A third example apparatus in accordance with some embodiments may include: a processor; and a non-transitory computer-readable medium storing instructions operative, when executed by the processor, to cause the apparatus to perform any one of the methods listed above.

A fourth example method in accordance with some embodiments may include: obtaining scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least a set action, and a set action information, wherein the set action information includes: a path, the path identifying the first scene element, and a value, the value indicating a new value for the first scene element; and in response to triggering execution of the set action, performing a first action, of the at least one action, on the first scene element.

A fourth example apparatus in accordance with some embodiments may include: a processor; and a non-transitory computer-readable medium storing instructions operative, when executed by the processor, to cause the apparatus to perform any one of the methods listed above.

A fifth example apparatus in accordance with some embodiments may include at least one processor configured to perform any one of the methods listed above.

A sixth example apparatus in accordance with some embodiments may include a computer-readable medium storing instructions for causing one or more processors to perform any one of the methods listed above.

A seventh example apparatus in accordance with some embodiments may include at least one processor and at least one non-transitory computer-readable medium storing instructions for causing the at least one processor to perform any one of the methods listed above.

An example signal in accordance with some embodiments may include: a scene description file generated according to any one of the methods listed above.

A further example apparatus in accordance with some embodiments may include: a processor; and a non-transitory computer-readable medium storing instructions operative, when executed by the processor, to cause the apparatus to perform the method listed above.

### BRIEF DESCRIPTION OF THE DRAWINGS

FIG. 1A is a schematic side view illustrating an example waveguide display that may be used with extended reality (XR) applications according to some embodiments.

FIG. 1B is a schematic side view illustrating an example alternative display type that may be used with extended reality applications according to some embodiments.

FIG. 1C is a schematic side view illustrating an example alternative display type that may be used with extended reality applications according to some embodiments.

FIG. 1D is a system diagram illustrating an example set of interfaces for a system according to some embodiments.

FIG. 1E is a system diagram illustrating an example set of interfaces for a scene description (stored as an item in gITF.json), three video tracks, an audio track, and a JavaScript Object Notation (JSON) patch update track in an ISOBMFF file according to some embodiments.

FIG. 2 is a system diagram illustrating an example set of interfaces for an MPEG-I node hierarchy supporting elements of scene interactivity according to some embodiments.

FIG. 3 is a block diagram showing an example of logical relationships between trigger information (describing triggers 1 through n), action information (describing actions 1 through m), and behavior information (describing relationships between the triggers and actions) in which triggers and actions may refer to one or more nodes in a scene description, such as a hierarchical scene graph, according to some embodiments.

FIG. 4 is a schematic plan view illustrating example relationships of extended reality scene description objects according to some embodiments.

FIG. 5 is a data syntax diagram illustrating an example syntax for a data stream encoding an extended reality (XR) scene description according to some embodiments.

FIG. 6 is a data structure illustrating example JSON patch operations.

FIG. 7 is a process diagram illustrating example timed sample patches to be applied to a scene description file.

FIG. 8 is a process diagram illustrating further example timed sample patches to be applied to a scene description file.

FIG. 9 is a flowchart illustrating an example process for an event-based update according to some embodiments.

FIG. 10 is a data structure illustrating an example JSON patch operation according to some embodiments.

FIG. 11 is a data structure illustrating an example gITF file extract according to some embodiments.

FIG. 12 is a data structure illustrating an example SET action structure according to some embodiments.

FIG. 13 is a flowchart illustrating an example SET action process according to some embodiments.

FIGS. 14A-14B form a data structure illustrating an example UPDATE action structure according to some embodiments.

FIG. 15 is a flowchart illustrating an example UPDATE action process according to some embodiments.

FIG. 16 is a flowchart illustrating an example process for performing a set action according to some embodiments.

FIG. 17 is a flowchart illustrating an example process for performing an update action according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

### Extended-Reality (XR) Display Devices

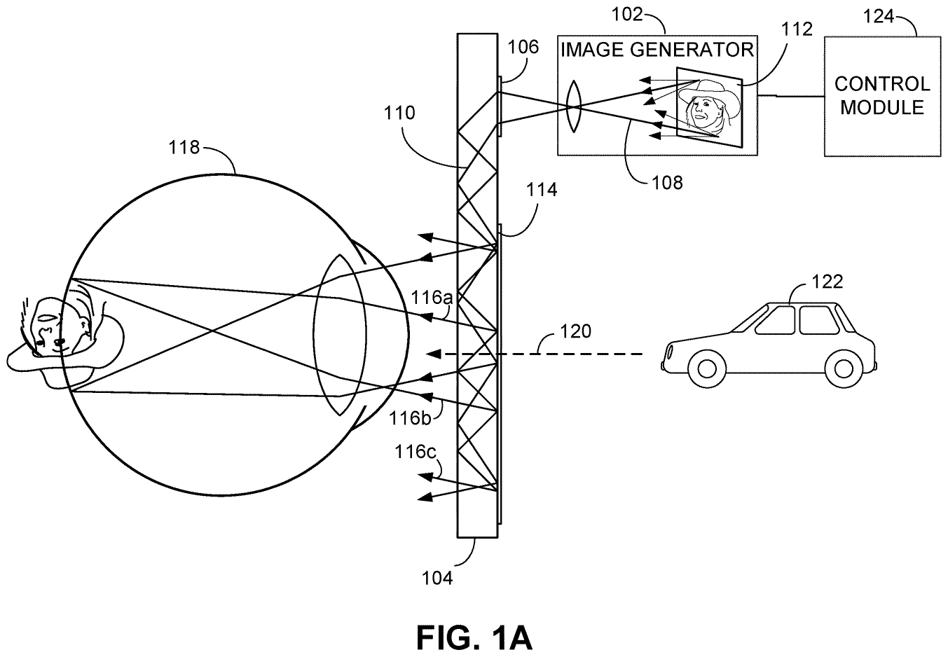

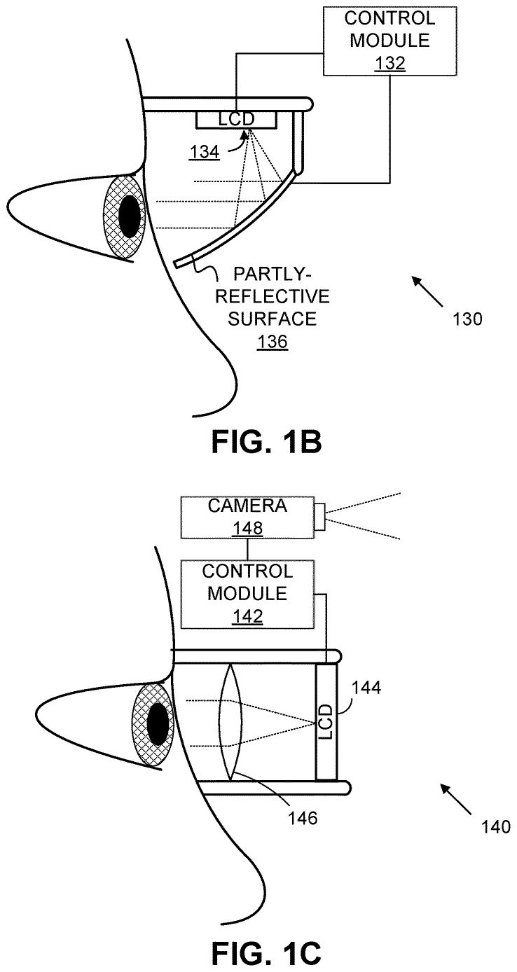

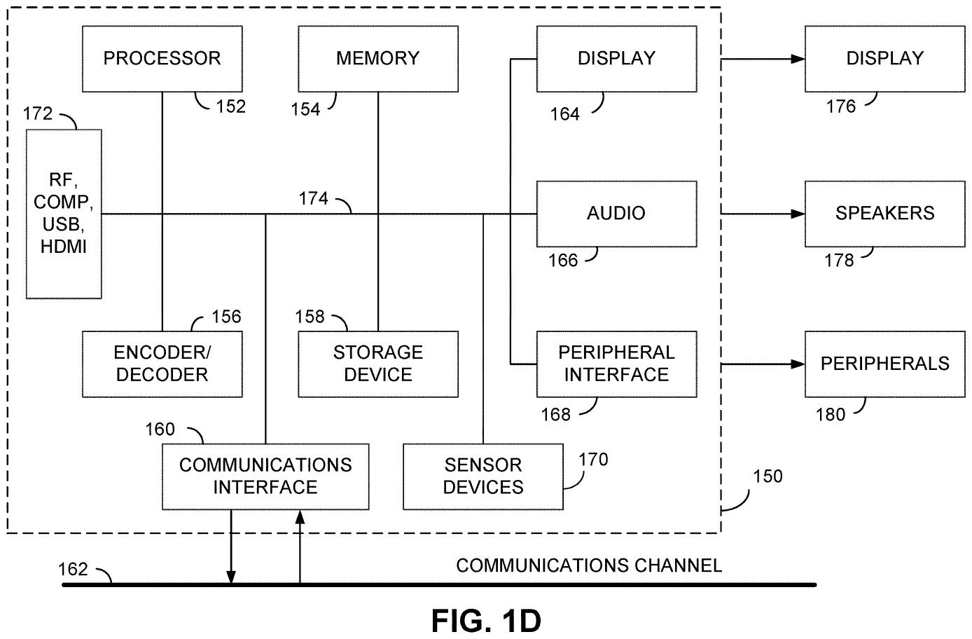

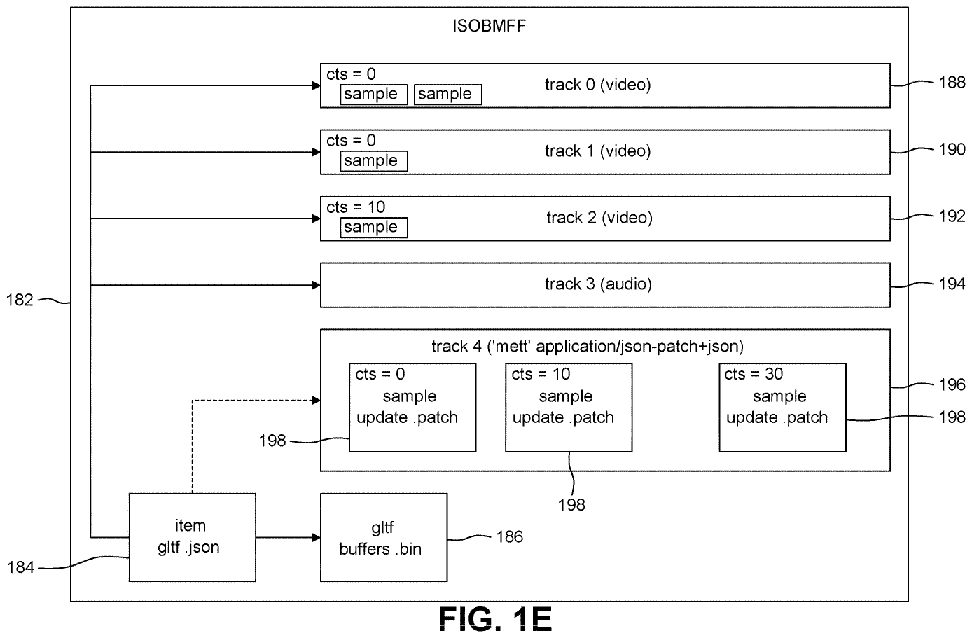

FIG. 1A is a schematic side view illustrating an example waveguide display that may be used with extended reality (XR) applications according to some embodiments. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (uLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection. The image generator 102 displays images as directed by a control module 124, which operates to render image data, video data, point cloud data, or other displayable data.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

FIG. 1B is a schematic side view illustrating an example alternative display type that may be used with extended reality applications according to some embodiments. In an XR head-mounted display device 130, a control module 132 controls a display 134, which may be an LCD, to display an image. The head-mounted display includes a partly-reflective surface 136 that reflects (and in some embodiments, both reflects and focuses) the image displayed on the LCD to make the image visible to the user. The partly-reflective surface 136 also allows the passage of at least some exterior light, permitting the user to see their surroundings.

FIG. 1C is a schematic side view illustrating an example alternative display type that may be used with extended reality applications according to some embodiments. In an XR head-mounted display device 140, a control module 142 controls a display 144, which may be an LCD, to display an image. The image is focused by one or more lenses of display optics 146 to make the image visible to the user. In the example of FIG. 1C, exterior light does not reach the user's eyes directly. However, in some such embodiments, an exterior camera 148 may be used to capture images of the exterior environment and display such images on the display 144 together with any virtual content that may also be displayed.

The embodiments described herein are not limited to any particular type or structure of XR display device.

FIG. 1D is a system diagram illustrating an example set of interfaces for a system according to some embodiments. An extended reality display device, together with its control electronics, may be implemented using a system such as the system of FIG. 1D. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 1000 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV.Link, Consumer Electronics Control (CEC), or other communications protocols that enable device-to-device control with or without user intervention. The output devices can be communicatively coupled to system 1000 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Scene Description Framework for XR

The present principles generally relate to the domain of rendering of extended reality scene description and extended reality rendering. The present document is also understood in the context of the formatting and the playing of extended reality applications when rendered on end-user devices such as mobile devices or Head-Mounted Displays (HMD).

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such MPEG scene description frameworks ensure that the timed media and the corresponding relevant virtual content are available at any time during the rendering of the application, there is no description of how a user can interact with the scene objects at runtime for immersive XR experiences.

There is a lack of an XR system that can take an XR scene description including metadata describing how a user can interact with the scene objects at runtime and how these interactions may be updated during runtime of the XR application.

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology-Coded representation of immersive media—Part14: Scene Description for MPEG media, ISO/IEC DIS 23090-14:2021 (E). A scene update mechanism based on the JavaScript Object Notation (JSON) Patch protocol as defined in IETF RFC 6902 may be used to synchronize virtual content to MPEG media streams.

FIG. 1E is a system diagram illustrating an example set of interfaces for a scene description (stored as an item in gITF.json), three video tracks, an audio track, and a JSON patch update track in an ISOBMFF (International Organization for Standardization (ISO) Base Media File Format) file according to some embodiments. The example ISOBMFF file structure 182 shows a gITF.json scene description item 184 is connected to a gITF storage buffer binary 186 and a JSON patch update track 196. The example gITF.json scene description item 184 is also connected to three example video tracks 188, 190, 192 and an audio track 194. Within the JSON update track 196 are three update patches 198.

Although the MPEG-I Scene Description framework ensures that the timed media and the corresponding relevant virtual content are available at any time, it does not provide a description of how a user can interact with the scene objects at runtime for immersive XR experiences. Hence, there is no support of user specific XR experiences for consuming the immersive media.

Example embodiments as described herein may be used to provide a scene description that includes a virtual object or light source but that does not necessarily display or render the virtual object or light source even if available. In some embodiments, one or more of the following aspects may be considered in determining whether to display a virtual object or light source.

A spatial aspect may be considered in determining whether to display a virtual object or light source. For example, if the user environment is not suited (e.g. the user is too far from the rendered timed media's location) or if the user is not looking toward the right direction, or if the virtual object should be displayed on a user-specific area (e.g. above his left hand which is not yet detected), then the virtual object or light source may not be displayed.

A temporal aspect may be considered in determining whether to display a virtual object or light source. For example, if the user is not yet ready or wants to trigger himself the display of the object (e.g. using a specific gesture), the virtual object or light source may not be displayed until the appropriate trigger is detected.

In some embodiments, it is specified in the scene description which objects or light sources the user is allowed to manipulate or to interact with through potential haptic feedbacks.

### Runtime Interactivity

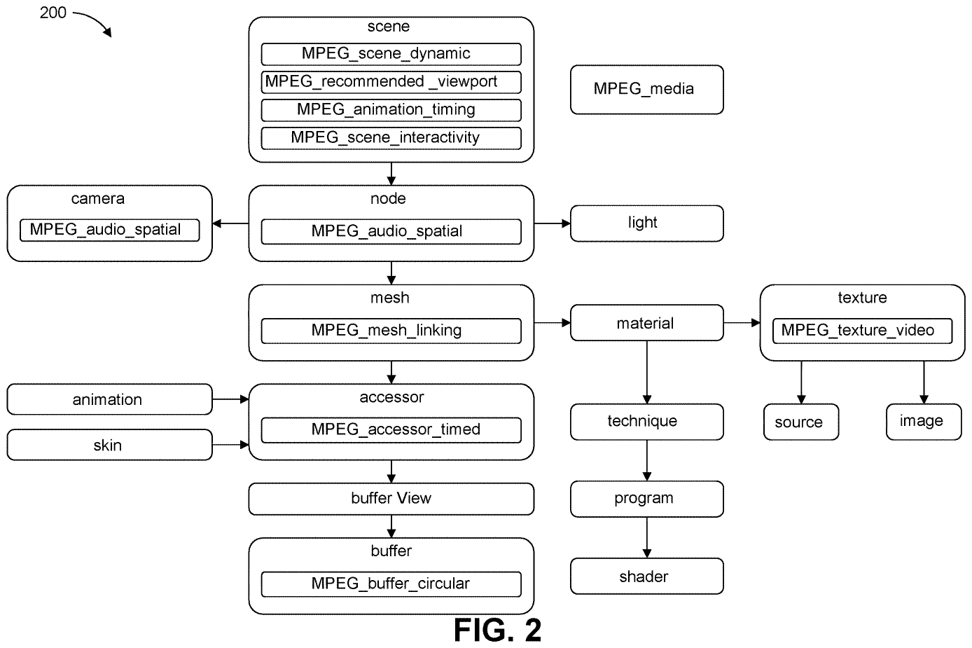

FIG. 2 is a system diagram illustrating an example set of interfaces for an MPEG-I node hierarchy supporting elements of scene interactivity according to some embodiments. The example node hierarchy 200 shows some example items that may be in a scene. According to the present principles, in addition to a node tree, behavior metadata items (examples of what are herein called ‘behaviors’) are added to the scene description. In example embodiments, the time-evolving scene description is augmented by adding information identifying behaviors. These behaviors may be related to pre-defined virtual objects on which runtime interactivity is allowed for user specific XR experiences.

In some embodiments, these behaviors are time-evolving. In such embodiments, the behaviors may be updated through the already-existing scene description update mechanism.

In example embodiments, a behavior is characterized by one or more of the following properties:
One or more triggers defining the conditions to be met for activation.
A trigger control parameter defining the logical operations between the defined triggers.
Actions to be implemented in response to the activation of the triggers.
An action control parameter defining the order of execution of the defined actions.
A priority number enabling the selection of the behavior of highest priority in the case of concurrence of several behaviors on the same virtual object at the same time.
An optional interrupt action to specify how to terminate this behavior when the behavior is no longer defined in a newly received scene update. For instance, a behavior is no longer defined if the related object has been removed or if the behavior is no longer relevant for this current media (e.g. audio or video) sequence.

With the addition of these behaviors, time-dependent user interactivity in immersive content for XR experiences may be defined.

When a second scene description is received, some of the behaviors of the first scene description may be “on-going”, e.g., they are triggered, and their actions are running. The second scene description may be provided as update metadata, e.g., metadata describing the differences between the first scene description and the second description. The second scene description includes a node tree describing objects that may be common or different than objects of the first scene descriptions. Objects of the node tree of the first scene description may be no longer present in the second description. If the objects related to the running actions of the on-going behaviors are missing in the second scene description, then, these on-going behaviors are no longer appliable. The same way, if an on-going behavior is not defined in the second description, the on-going behavior is no longer appliable. The interrupt action field describes how to correctly interrupt the running actions on the on-going behavior.

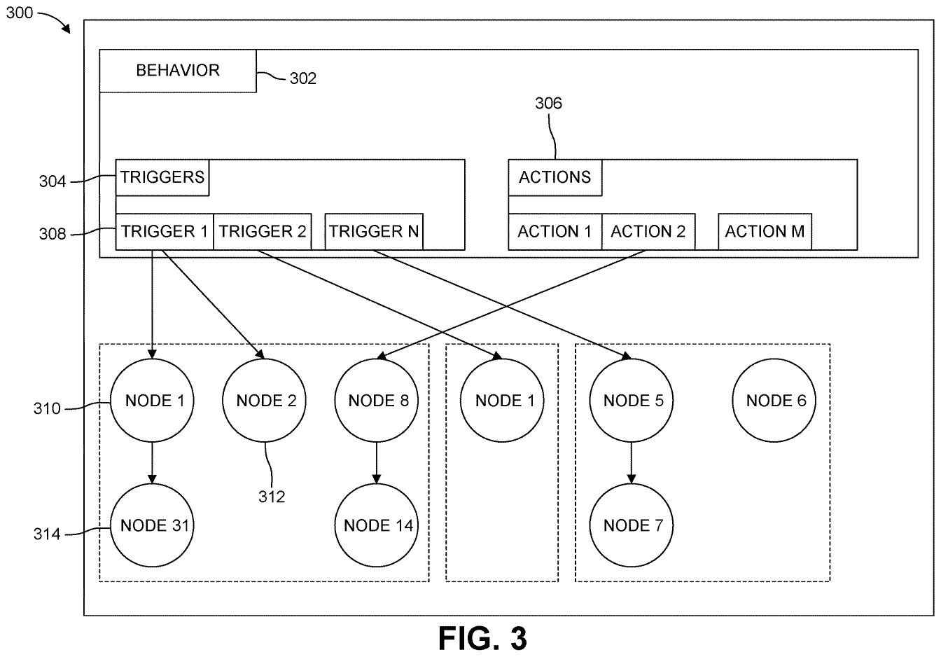

FIG. 3 is a block diagram showing an example of logical relationships between trigger information (describing triggers 1 through n), action information (describing actions 1 through m), and behavior information (describing relationships between the triggers and actions) in which triggers and actions may refer to one or more nodes in a scene description, such as a hierarchical scene graph, according to some embodiments. For example, Trigger 1 (308) directly refers to Node 1 (310) and Node 2 (312) (with Node 31 (314) as a child node of Node 1), in which Trigger 1 refers directly to Node 1. The example set 300 of logical relations may include behavior information 302, trigger information 304, and action information 306.

In XR applications, a scene description is used to combine explicit and easy-to-parse description of a scene structure and some binary representations of media content. The above sections describe action mechanisms for scene descriptions. These behaviors are related to pre-defined virtual objects on which runtime interactivity is allowed for user specific XR experiences. FIG. 3 illustrates the structure of an example behavior mechanism.

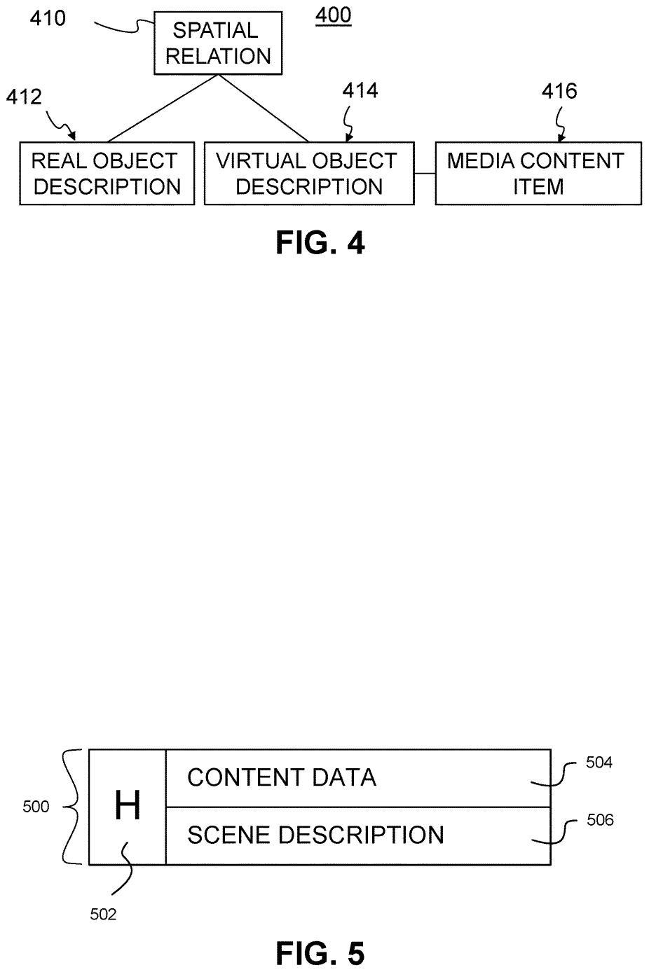

FIG. 4 is a schematic plan view illustrating example relationships of extended reality scene description objects according to some embodiments. In this example, the scene graph 400 includes a description of a real object 412, for example ‘plane horizontal surface’ (that can be a table or the floor or a plate) and a description of a virtual object 414, for example an animation of a walking character. Scene graph node 414 is associated with a media content item 416 that is the encoding of data used to render and display the walking character (for example as a textured animated 3D mesh). Scene graph 400 also includes a node 410 that is a description of the spatial relation between the real object described in node 412 and the virtual object described in node 414. In this example, node 410 describes a spatial relation to make the character walk on the plane surface. When the XR application is started, media content item 416 is loaded, rendered and buffered to be displayed when triggered. When a plane surface is detected in the real environment by sensors (or a camera for some embodiments), the application displays the buffered media content item as described in node 410. The timing is managed by the application according to features detected in the real environment and to the timing of the animation. A node of a scene graph may also include no description and only play a role of a parent for child nodes.

XR applications are various and may apply to different context and real or virtual environments. For example, in an industrial XR application, a virtual 3D content item (e.g. a piece A of an engine) is displayed when a reference object (piece B of an engine) is detected in the real environment by a camera rigged on a head mounted display device. The 3D content item is positioned in the real-world with a position and a scale defined relatively to the detected reference object.

For example, in an XR application for interior design, a 3D model of a furniture is displayed when a given image from the catalog is detected in the input camera view. The 3D content is positioned in the real-world with a position and scale which is defined relatively to the detected reference image. In another application, some audio file might start playing when the user enters an area which is close to a church (being real or virtually rendered in the extended real environment). In another example, an ad jingle file may be played when the user sees a can of a given soda in the real environment. In an outdoor gaming application, various virtual characters may appear, depending on the semantics of the scenery which is observed by the user. For example, birds characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger; Furthermore, the sound may be spatialized in order to make it arrive from the direction where the car was detected.

An XR application may also augment a video content rather than a real environment. The video is displayed on a rendering device and virtual objects described in the node tree are overlaid when timed events are detected in the video. In such an example context, the node tree includes only virtual objects descriptions.

Example embodiments are described with reference to the scope of the MPEG-I Scene Description framework using the Khronos gITF (Graphics Language Transmission Format or GL Transmission Format) extension mechanism, which supports additional scene description features, such as a node tree. However, the principles described herein are not limited to a particular scene description framework.

In accordance with some example embodiments, the gITF scene description is extended to support interactivity. The interactivity extension applies at the gITF scene level and is called MPEG_scene_interactivity. The corresponding semantics are provided in Table 1.

TABLE 1
Semantics of an Example MPEG_Scene_Interactivity Extension

| Name | Type | Usage | Default | Description |
|---|---|---|---|---|
| Triggers | array | M | [ ] | Contains the definition of all the |
| | | | | triggers used in that scene |
| Actions | array | M | [ ] | Contains the definition of all the |
| | | | | actions used in that scene |
| Behaviors | array | M | [ ] | Contains the definition of all the |
| | | | | behaviors used in that scene. A |
| | | | | behavior is composed of, e.g., a |
| | | | | pair of (triggers, actions), control |
| | | | | parameters of triggers and actions, |
| | | | | a priority weight and an optional |
| | | | | interrupt action |

In Table 1 and other semantic tables described herein, the “usage” column indicates “M” for “mandatory” features and “O” for “optional” features. However, such features may be “mandatory” or “optional” only according to a particular proposed syntax. A feature marked “mandatory” is not necessarily a required feature to implement the application. For example, in some embodiments, a feature marked “mandatory” is present to satisfy the expectations of a particular type of parsing and rendering software; however, in other embodiments, that feature may be optional, or the feature may be omitted entirely, with the corresponding functionality being implemented using default values or not being implemented at all without departing from the scope of the present disclosure.

FIG. 5 is a data syntax diagram illustrating an example syntax for a data stream encoding an extended reality (XR) scene description according to some embodiments. The structure consists in a container which organizes the stream in independent elements of syntax. The structure 500 may include a header part 502 which is a set of data common to every syntax element of the stream. For example, the header part includes metadata about syntax elements, describing the nature and the role of each of them. The structure also includes a payload including an element of syntax 504 and an element of syntax 506. Syntax element 504 includes data representative of the media content items describes in the nodes of the scene graph related to virtual elements. Images, meshes and other raw data may have been compressed according to a compression method. Element 506 is a part of the payload of the data stream and includes data encoding the scene description.

In XR applications, a scene description may be used to combine explicit and easy-to-parse description of a scene structure and some binary representations of media content. In time-based media streaming, the scene description itself may be time-evolving to provide relevant virtual content for each sequence of a media stream. For instance, for advertising purposes, a virtual bottle may be displayed on a table during a video sequence in which people sit around the table. This kind of behavior may be achieved by using the framework of INFORMATION TECHNOLOGY—CODED REPRESENTATION OF IMMERSIVE MEDIA—PART 14: SCENE DESCRIPTION FOR MPEG MEDIA, ISO/IEC DIS 23090-14:2021 (E) (2021) (“MPEG-/Scene Description”). Although the MPEG-I Scene Description framework allows the timed media and the corresponding relevant virtual content to be available at any time, there is no description of how a scene may be updated based on runtime interactivity.

In the MPEG-/Scene Description document, a scene update mechanism is proposed. A special track in a media content file (for instance, an ISOBMFF (International Organization for Standardization (ISO) Base Media File Format) file) may provide timed patches to be applied to an original scene description. Such patches may be JSON (JavaScript Object Notation) patches as described in JAVASCRIPT OBJECT NOTATION (JSON) PATCH, IETF RFC 6902, available at datatracker<dot>ietf<dot>org/doc/html/rfc6902 (“JSON Patch”). This mechanism handles pre-defined scene evolution but does not allow describing event-based update following, for instance, a user action or any event that may occur among the scene objects at any time.

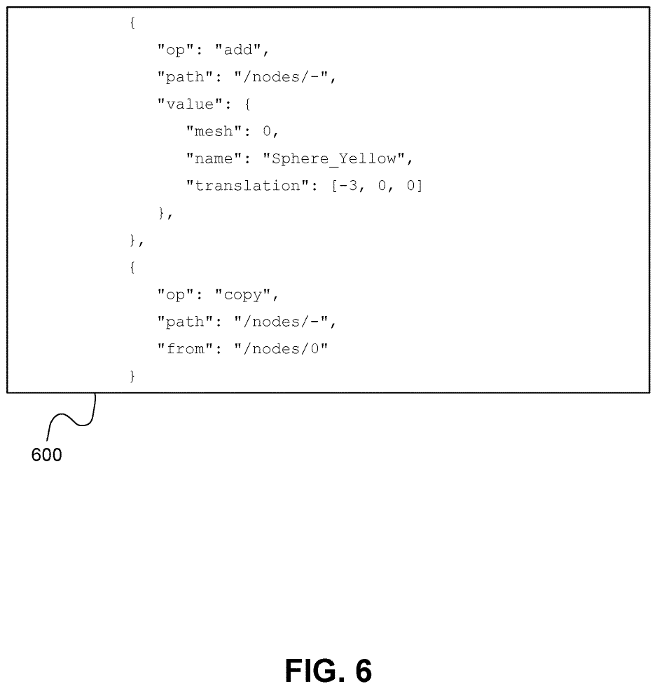

FIG. 6 is a data structure illustrating example JSON patch operations. As discussed in the JSON Patch document, a patch contains an array of operations (add, remove, replace, move, and copy). Each operation specifies a type (“op”); a JSON element to address (“path”); and, if needed, a value to apply (“value”) or a source JSON element (“from”). FIG. 6 provides a code listing 600 with an example JSON Patch that includes two example JSON Patch operations. The first example operation is an “add” operation that adds a new node at the end of the gITF (Graphics Language Transmission Format) nodes array. The parameters of the new node in accordance with the first example operation comes from a JSON string (“value”) signifying a new node and has a “mesh” value of zero, referencing the first element of the gITF meshes array, a “name” of “Sphere Yellow”, and a “translation” value of [-3, 0, 0]. The second example operation is a “copy” operation that copies existing node 0 (hence a source JSON element (“from”) to the end of the gITF nodes array.

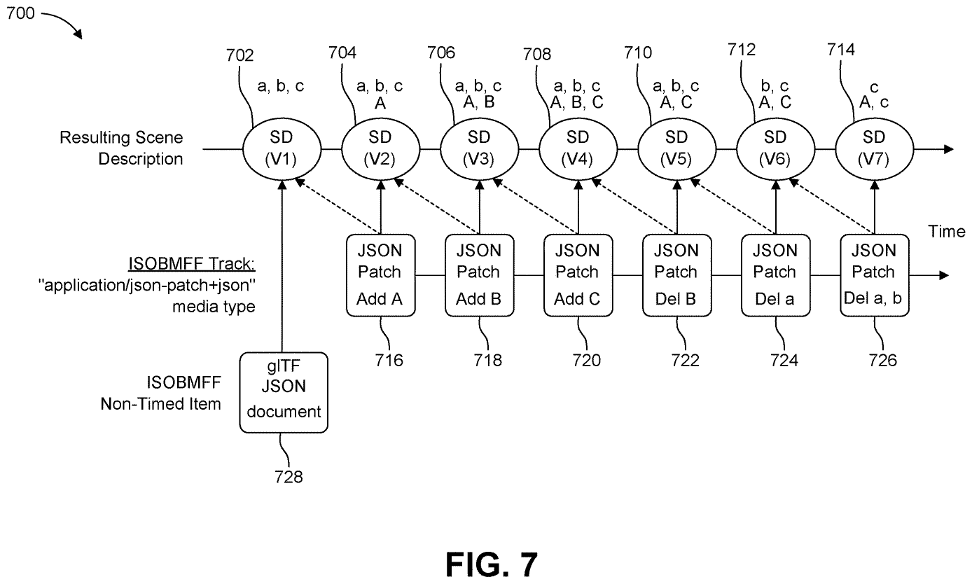

FIG. 7 is a process diagram illustrating example timed sample patches to be applied to a scene description file. A non-timed item, which in this case is a gITF JSON document 728, is loaded as version 1 of the scene description (SD (V1). According to the example 700, a series of JSON patches 716, 718, 720, 722, 724, 726 are applied to successive versions 702, 704, 706, 708, 710, 712, 714 of the scene description. The dashed line arrows indicate that the respective patch points to the previous scene description and the solid line arrows indicate a resulting updated scene description outputted as a new version. In other words, for one example from FIG. 7, a JSON Patch 722 that includes a JSON patch remove operation summarized as “Del B” or “Delete B” is applied to Scene Description Version 4 (“SD (V4)”) 708 to remove element “B” from the element set {a, b, c, A, B, C}, resulting in Scene Description Version 5 (“SD (V5)”) 710 having the reduced element set {a, b, c, A, C}.

More specifically, for further examples shown in FIG. 7, the patches are “application/json-patch+json” media type JSON patches. In this example, version 1 (702) of the scene has elements “a”, “b”, and “c”. The first patch 716 adds element “A” to make version 2 (704) of the scene elements be “a”, “b”, “c”, and “A”. The second patch 718 adds element “B” to make version 3 (706) of the scene elements be “a”, “b”, “c”, “A”, and “B”. The third patch 720 adds element “C” to make version 4 (708) of the scene elements be “a”, “b”, “c”, “A”, “B”, and “C”. The fourth patch 722 deletes element “B” to leave version 5 (710) of the scene as elements “a”, “b”, “c”, “A”, and “C”. The fifth patch 724 deletes element “a” to leave version 6 (712) of the scene as elements “b”, “c”, “A”, and “C”. The sixth patch 726 deletes elements “a” and “b” to leave version 7 (714) of the scene as elements “c”, “A”, and “C”. Element “a” was already deleted, so attempting to delete element “a” again has no effect.

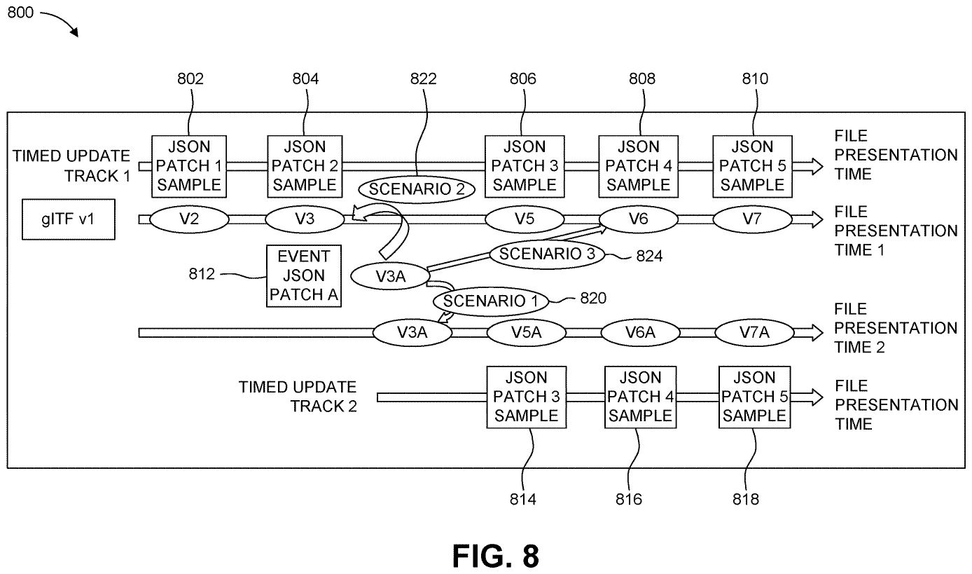

FIG. 8 is a process diagram illustrating further example timed sample patches to be applied to a scene description file. In the scene update document, EXPLORATION EXPERIMENTS ON DYNAMIC SCENE UPDATE, ISO/IEC JTC 1/SC 29/WG 3 N0315 (August 2021) (“MPEG-/Scene Description Update”), an event-based scene update mechanism is proposed. While a predefined timed scene update is in progress, as described above, an event (e.g., a user input, a collision between two objects, or an object becomes visible) may occur that triggers an additional update to the scene description. A new scene description version is created (SD version 3A) via Patch A 812 that modifies the predefined timed scene update flow of patches 802, 804, 806, 808, 810. Several scenarios are then proposed, such as: (1) scenario 1 (820): apply a patch and switch to a new timed samples track (SD version 3A, SD version 5A, . . . ), (2) scenario 2 (822): apply a patch and switch back to the previous version of the scene description and continue the same predefined timed scene update flow; or (3) scenario 3 (824): apply a patch and skip one or more versions in the same track. FIG. 8 shows a set 800 of examples of these scenarios, which are labeled as scenario 1, 2, and 3. For some embodiments, a second set of timed scene updates may have a series of patches 814, 816, 818.

This described event-based scene update mechanism is still strongly related to pre-defined scene evolutions and does not specify how the event that triggers the update is described in the scene description document. Furthermore, this mechanism does not handle the case where the same event that creates a new node may be fired multiple times. The number of times that the same patch has been applied when a new action occurs is unknown.

For example, creating a new node as a child of an existing node may be done using 2 patch operations. Add a new JSON element at the end of the gITF nodes array (op=“add” and path=“/nodes/−”) for the new node. Then, modify the child array of the parent node by adding the index of the new node (op=“add” and path=“/nodes/0/children/−”). The challenge is that there is no means to know the index (which would be used as the value parameter) of this new node, except for the first execution of the patch. This challenge is why extra parameters like placedItems, chilOps, or parents may be used in an UPDATE action.

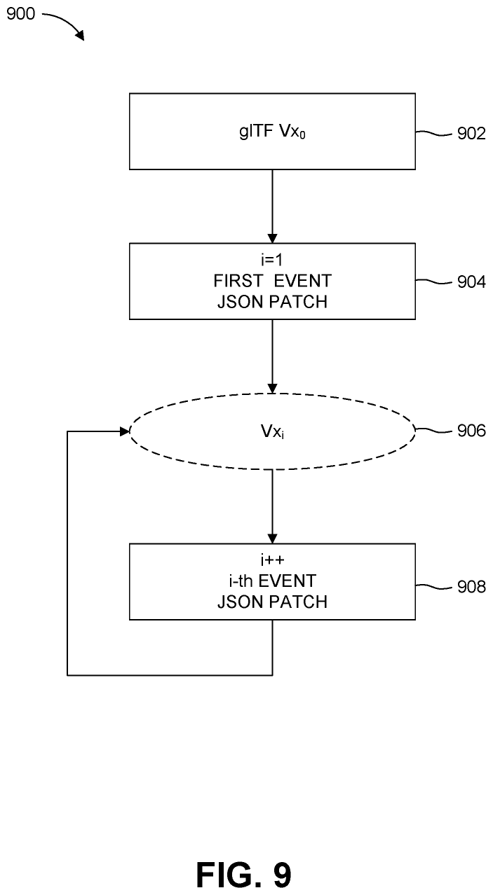

FIG. 9 is a flowchart illustrating an example process for an event-based update according to some embodiments. In this example 900, a gITF scene (Vx) contains a description of an event-based update mechanism with the same patch applied each time an event, such as a user clicking on a touch screen, occurs. Some elements of the gITF scene are modified, but the event-based update description is not modified. For example, a new object (a cube) is added to the scene each time a user clicks on a touch screen. Version 0 of the gITF scene is Vx₀ 902, which is shown at the top of FIG. 9. The loop counter i is initialized 904 to 1 for the first event, and the first JSON patch is applied to generate version 1 of the scene, Vx₁. For each further event, the loop counter i is incremented and the i-th JSON patch is applied 908 to generate version i of the scene, Vxᵢ 906.

European patent application no. 22305024.6 (“'024 application”) discusses an augmentation of a time-evolving scene description by adding “behavior” data. This augmentation is being integrated in a draft amendment of the MPEG-/Scene Description document. These behaviors are related to pre-defined virtual objects on which runtime interactivity is allowed for user specific XR experiences. These behaviors are also time-evolving and may be updated through the already-existing scene description update mechanism.

For some embodiments, a behavior is a metadata item which may include:
triggers defining the conditions to be met for their activation
a trigger control parameter defining logical operations between the triggers. actions to be processed when the triggers are activated
an action control parameter defining the order of execution of the defined actions
a priority number enabling the selection of the behavior of highest priority in case of concurrence of several behaviors on the same virtual object at the same time
an optional interrupt action to specify how to terminate this behavior when the behavior is no longer defined in a newly received scene update

For instance, a behavior is no longer defined if the related object does not belong to the new scene or if the behavior is no longer relevant for the current media (e.g., audio or video) sequence.

The semantic of an action is shown in Table 2.

TABLE 2
Action semantic

| Name | Type | Usage | Default | Description |
|---|---|---|---|---|
| type | enumeration | M | ACTIVATE | Defines the type of the action by |
| | | | | taking one of the following values: |
| | | | | ACTIVATE = 0, |
| | | | | TRANSFORM = 1, |
| | | | | ANIMATE = 2, |
| | | | | CONTROL_MEDIA = 3, |
| | | | | PLACE_AT = 4, |
| | | | | MANIPULATE = 5, |
| | | | | SET_MATERIAL = 6 |
| delay | number | O | | Duration of delay in second before |
| | | | | executing the action |
| If (type == ACTIVATE){ | | | | |
| ... | | | | |
| } | | | | |
| If (type == TRANSFORM){ | | | | |
| ... | | | | |
| } | | | | |
| ... | | | | |

The framework of Table 2 may be extended to allow other action types. The present application discusses new action types to handle event-based scene updates in accordance with some example embodiments. These new action types may be added to the framework of Table 2.

Furthermore, the scene update mechanism described above regarding FIG. 8 in accordance with MPEG-I Scene Description Update only considers a private usage of the scene with only local updates. The present application also discusses a new parameter that allows the sharing of the update with all clients that may be connected to the same scene.

The present application uses the MPEG-I Scene Description framework and the interactivity framework described in the '024 application. In accordance with some embodiments, a scene description may be augmented by specializing the Action semantic based on the interactivity framework of the '024 application to add 2 new action categories: a SET action and an UPDATE action.

A SET action updates a gITF element in a scene description document. This element may be addressed using a JSON pointer, which is described in the document JAVASCRIPT OBJECT NOTIFICATION (JSON) POINTER, IETF RFC 6901, available at datatracker<dot>ietf<dot>org/doc/html/rfc6901 (“JSON Pointer”). This action may replace the actions that update only single elements of a gITF tree (e.g., a SET_MATERIAL action).

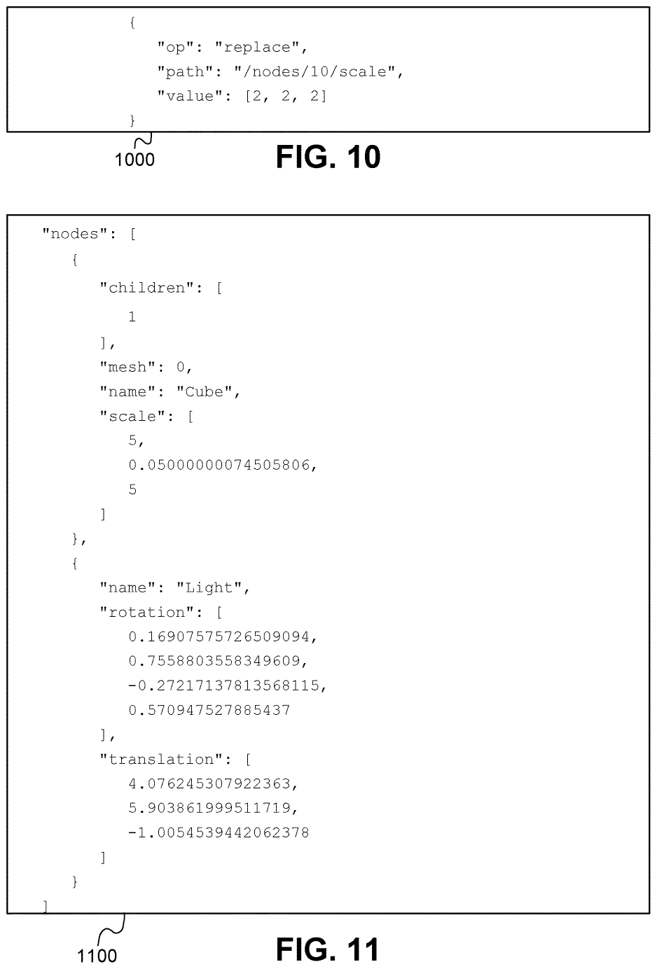

While multiple SET actions may be used to perform advanced updates in the scene, in some implementations such an update process using multiple SET actions may become cumbersome for the creation or removal of new nodes. An UPDATE action performs more sophisticated updates based on the JSON patches used in the document MPEG-/Scene Description Update. The UPDATE action contains a scene update patch that includes an array of operations (add, remove, replace, move, or copy). A single replace operation may be performed by a SET action. Each patch operation specifies its type (“op”), the JSON element to address (“path”), and, if needed or as applicable, a value to apply (“value”) or a source JSON element (“from”). The example given in FIG. 10 replaces (or sets) the scale value of node 10 to [2, 2, 2].

For both SET and UPDATE actions, a location parameter (placeDescription) is specified to get a position from a user input device or function (such as, e.g., a hand position or a digit position on a touchscreen). This position may be used to calculate the new value for the SET action, or the place of a new node (or a nodes tree) added by the UPDATE action. Also, for both SET and UPDATE actions, a parameter (shared) is specified that allows the update to be applied to all the devices that are connected in the same session and that share the same 3D scene.

FIG. 10 is a data structure illustrating an example JSON patch operation according to some embodiments. For this example code listing 1000, the operation type (“op”) is a “replace” operation. The path (“path”) parameter is a JSON pointer string. The path parameter points to the location of a node. The value (“value”) parameter is the new value. In this example, the “scale” for node “10” is replaced with the value [2, 2, 2]

Table 3 below gives the semantics of the SET action with the definition of the parameters of the new action.

TABLE 3
Action Semantics with a SET Action

| Name | Type | Usage | Default | Description |
|---|---|---|---|---|
| type | enumeration | M | ACTIVATE | Defines the type of action as one of |
| | | | | the following values: |
| | | | | ACTIVATE = 0, |
| | | | | TRANSFORM = 1, |
| | | | | ANIMATE = 2, |
| | | | | CONTROL_MEDIA = 3, |
| | | | | PLACE_AT = 4, |
| | | | | MANIPULATE = 5, |
| | | | | SET = 7 |
| ... | | | | |
| If (type == SET){ | | | | |
| path | string | M | “” | A JSON pointer referencing an |
| | | | | element of the scene gITF tree |
| pathType | | M | float | String, Scalar (float, byte, u_byte, |
| | | | | short, u_short), array of scalars, |
| | | | | vec3, vec4... |
| value | simple type | M | 0 | The new value for the path |
| | or JSON | | | element. |
| | string | | | |
| shared | boolean | M | false | If true, the action must be applied |
| | | | | on all the devices that are |
| | | | | connected in the same session and |
| | | | | that share the same 3D scene. |
| placeDescription | string | O | | If the target is a node element |
| | | | | (e.g., “/nodes/1”) or a |
| | | | | translation/orientation element, the |
| | | | | placeDescription string indicates |
| | | | | the value to use for a position |
| | | | | calculation, instead of the “value” |
| | | | | parameter. The placeDescription |
| | | | | string may be an OpenXR path, |
| | | | | e.g., “/input/trackpad/click” |
| | | | | “/input/aim/pose” |

In the action structure as shown in Table 3, the SET_MATERIAL action type is deleted, and the SET action type is added. The elements of the SET action structure are also added as shown in Table 3.

The path parameter indicates an element (e.g., a scene element) in the scene description gITF tree. The scene description gITF tree is a JSON tree, and the JSON pointer semantic as described in the JSON Pointer document may be used with the path parameter.

The pathType parameter depends on the targeted element. The path Type parameter may be, for example, a type for leaf elements: string, float, byte, short, boolean, or an array.

If an element is a sub-tree (for instance, “/node/1”), the value parameter is a JSON string in order to describe a gITF sub-tree.

To handle use cases where multiple connected clients share the same 3D scene, the shared parameter is introduced. When the shared parameter is set to TRUE, the action is performed in all clients, so that the scene rendering is synchronized everywhere. The action may be performed by forwarding the trigger activation state, so that all clients trigger the action execution, as if the trigger had occurred locally for each of the clients. The action also may be performed by forwarding the scene update information to be applied by each client.

The placeDescription parameter is used in case the SET action manipulates a gITF node to be placed at a particular position (e.g., a position within the scene), related to a user input. In that case, the path is a node root or a location element of a node. If the path is a node root (e.g., “/nodes/1”), the translation and the rotation value of this node is set according to the placeDescription value. If the path is a location element of a node (e.g., “/node/2/translation” or “/node/2/rotation”), only this element is set. For some embodiments, the placeDescription value is a string parameter, containing the description of the user input, e.g., “/user/hand/left/grip” or “/user/hand/left/input/trackpad/touch” as specified in THE OPENXR SPECIFICATION, available at:

www<dot>khronos<dot>org/registry/OpenXR/specs/1.0/html/xrspec<dot>html#semantic-path-interaction-profiles for the interaction profile path.

This path is used by the 3D engine to provide location information like translation and orientation of a user element or a 2D position of a user's finger touching a touch screen. This information can be directly used to set a positioning element of the gITF file or may require additional operation (e.g., 2D to 3D conversion, or conversion from a 3D XR space to another).

Since the placeDescription may refer to an absolute 3D position, in some embodiments positioning shall be done according to a parent node if any. Extra parameters may be added to specify how the placement should be processed: directly to the new position without any transition, linear transition to the new position . . . .

FIG. 11 is a data structure illustrating an example gITF file extract according to some embodiments. The example code listing 1100 of an example gITF file extract in FIG. 11 shows an example structure of a parent node and a child node. The parent node has a “name” parameter of “Cube”. The “scale” parameter for the parent node is an array with values of [5, 0.05000000074505806, 5].

The child node has a “name” parameter of “Light”. The “rotation” parameter for the child node is an array with values of [0.16907575726509094, 0.7558803558349609, −0.27217137813568115, 0.570947527885437]. The “translation” parameter for the child node is an array with values of [4.076245307922363, 5.903861999511719, −1.0054539442062378].

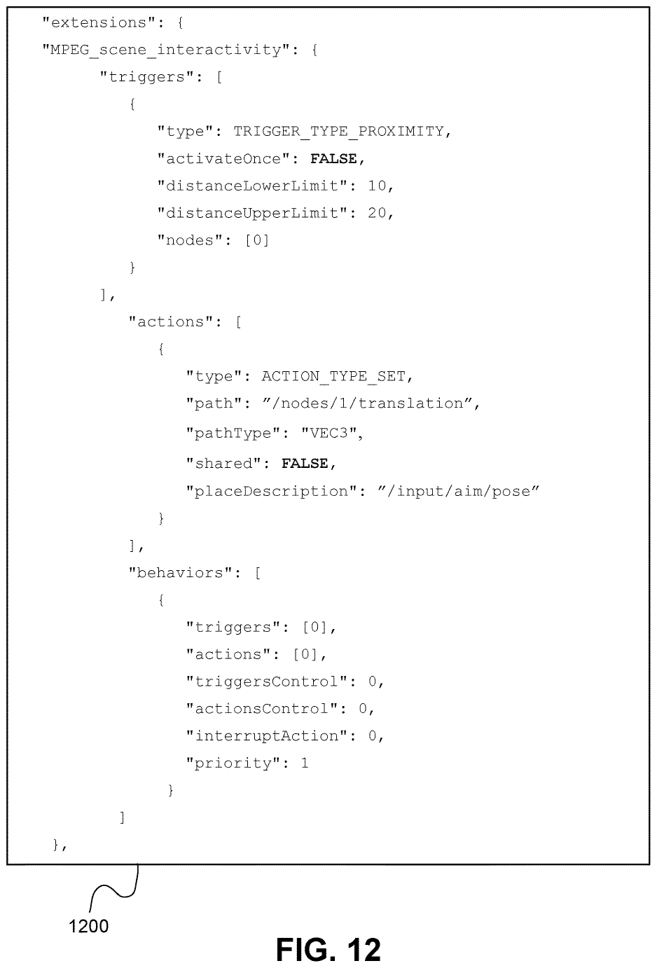

FIG. 12 is a data structure illustrating an example SET action structure according to some embodiments. For this example code listing 1200, a proximity trigger, which is shown in FIG. 12 with a type of “TRIGGER_TYPE_PROXIMITY” and has a value of 1, activates a SET action. In FIG. 12, a SET action has a type of “ACTION_TYPE_SET” and a value of 7. When the user/camera is close (a distance between 10 m (distanceLowerLimit) and 20 m (distanceUpperLimit) to node 0 (“[0]”), the translation value of the node 1 is set to the position where the user is pointing (position of the user's digit . . . ) because the “path” parameter is “/nodes/1/translation”. To address the translation element of node 1, the path value is set to: “/nodes/1/translation”. For the example shown in FIG. 12, the path Type is VEC3.

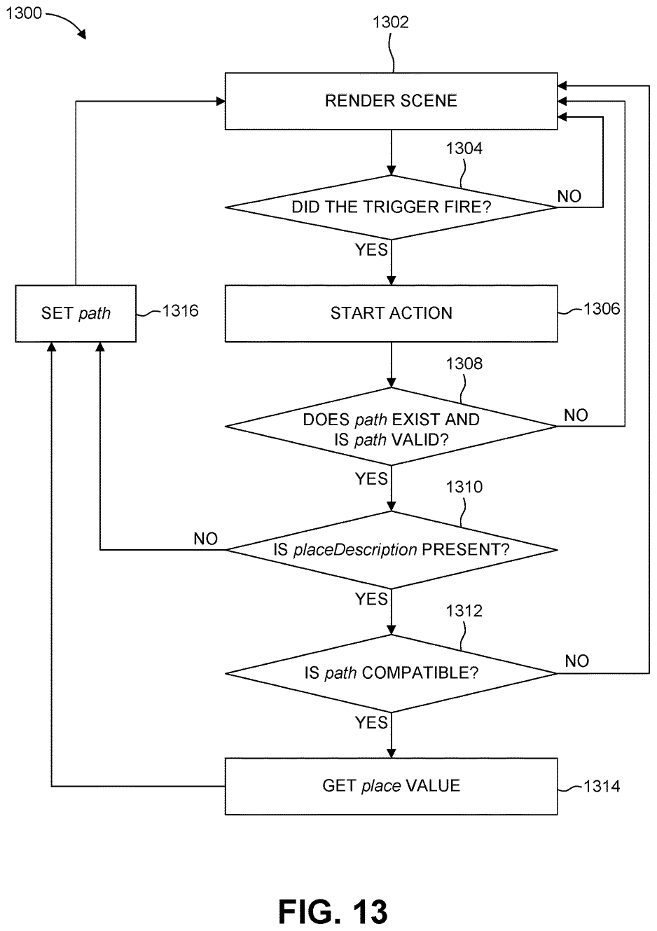

FIG. 13 is a flowchart illustrating an example SET action process according to some embodiments. In the example SET action process 1300, if a trigger is detected 1304 as firing, then flow progresses to the start action box 1306. Otherwise, flow returns to render 1302 the scene.

At the start action box 1306, the parameters are checked. Does the path exist in the gITF description file 1308? Do the pathType and the value parameters match the pointed gITF element? If the path does not exist or is not valid, then flow progress returns to render the scene.

If the placeDescription parameter is present 1310, then the flowchart progresses to ask if the path is compatible 1312. If the path is not compatible, then the flowchart progress returns to render the scene. If the path is compatible, then the flowchart progresses to get the place value 1314 and then flow progresses to the set path box 1316.

If the placeDescription parameter is not present, then flow progresses to the set path box 1316.

At the set path box, the gITF element identified by path parameter is set with the value parameter, or with a location information retrieved from the placeDescription parameter (“Get place value” step). In this latter case, a user input (click, touch) or a user body element (e.g., left hand or a finger) may be monitored for detection of triggering.

Table 4 below gives the semantics of the UPDATE action with the definition of the parameters of the new action.

TABLE 4
Action Semantics with an UPDATE Action#

| Name | Type | Usage | Default | Description |
|---|---|---|---|---|
| type | enumeration | M | ACTIVATE | Defines the type of action as one of |
| | | | | the following values: |
| | | | | ACTIVATE = 0, |
| | | | | TRANSFORM = 1, |
| | | | | ANIMATE = 2, |
| | | | | CONTROL_MEDIA = 3, |
| | | | | PLACE_AT = 4, |
| | | | | MANIPULATE = 5, |
| | | | | SET = 7, |
| | | | | UPDATE = 8 |
| ... | | | | |
| If (type == SET){ | | | | |
| ... | | | | |
| } | | | | |
| If (type == UPDATE){ | | | | |
| patch | string | M | { } | A JSON patch to apply to the |
| | | | | current scene description, or a |
| | | | | Universal Resource Identifier (URI) |
| | | | | to a JSON file containing the patch. |
| shared | boolean | M | false | If true, the action must be applied |
| | | | | on all the devices that are |
| | | | | connected in the same session and |
| | | | | that share the same 3D scene. |
| placedItems | array | O | | Indicates the indices of the |
| | | | | referenced patch operations to |
| | | | | consider for the place description. |
| placeDescription | string | O | | If the path of an operation |
| | | | | referenced in placedItems is a |
| | | | | node element (e.g., “/nodes/1”) or |
| | | | | a translation/orientation element, |
| | | | | the placeDescription string |
| | | | | indicates the value to use for a |
| | | | | position calculation, instead of the |
| | | | | “value” parameter. The |
| | | | | placeDescription may be an |
| | | | | OpenXR path, e.g., |
| | | | | “/input/trackpad/click” |
| | | | | “/input/aim/pose” |
| childOps | array | O | | Indicates the indices of the |
| | | | | referenced patch operations to |
| | | | | address for the parent description. |
| parents | array | O | | Indicates the nodes of where to |
| | | | | add each new child referenced in |
| | | | | childOps array. |
| } | | | | |
| ... | | | | |

The patch parameter describes the patch to be applied to the gtTF scene. Following the JSON patch semantic of the JSON Patch document, the patch parameter is a string that describes one or more operations (add, remove, replace, move, or copy) to apply to JSON elements, which are addressed with a JSON pointer. Each operation contains a set of parameters: an operation identifier (“op”), a path to a JSON element (“path”), and depending on the operation, a value (“value”) or a source JSON element (“from”).

The shared and placeDescription parameters are the same as in the SET action, except that the placeDescription parameter needs an extra parameter to identify a node: The placedItems array contains the indices of patch operations in the patch array. These operations identify the nodes to position (if the path of these operations is a node root (e.g., “/nodes/1”) or a location element of a node (e.g., “/node/2/translation”). If one or more gITF nodes are created with one or more “add” or “copy” patch operations, these nodes may be added as children of an existing node.

One or more scene elements may be placed at a given location. The patch operations in the placedItems list are operations that handle scene elements that may be moved (e.g., a node representing a 3D object may be moved). For some embodiments, update action information may further include a place description field and a placedItems field. The place description field may identify a source of location information, and the placedItems field may identify patch operations that reference nodes that are to be placed at a given location.

Two array parameters identify the child nodes and their respective parent nodes: the childOps and parents arrays. The childOps array gives the indices of operations in the patch array that create a child node. The parent nodes of these children are given in the parents array. The parents array contains only indices of nodes that already exist in the original gITF document.

For some embodiments, the processing model for the management of these parameters by the rendering application is as follows:
The processor executes the patch operations which leads to a first modification of the gITF file.
The processor gets the indices of the new nodes.
The processor modifies the children array of the parent nodes which leads to a second modification of the gITF file.

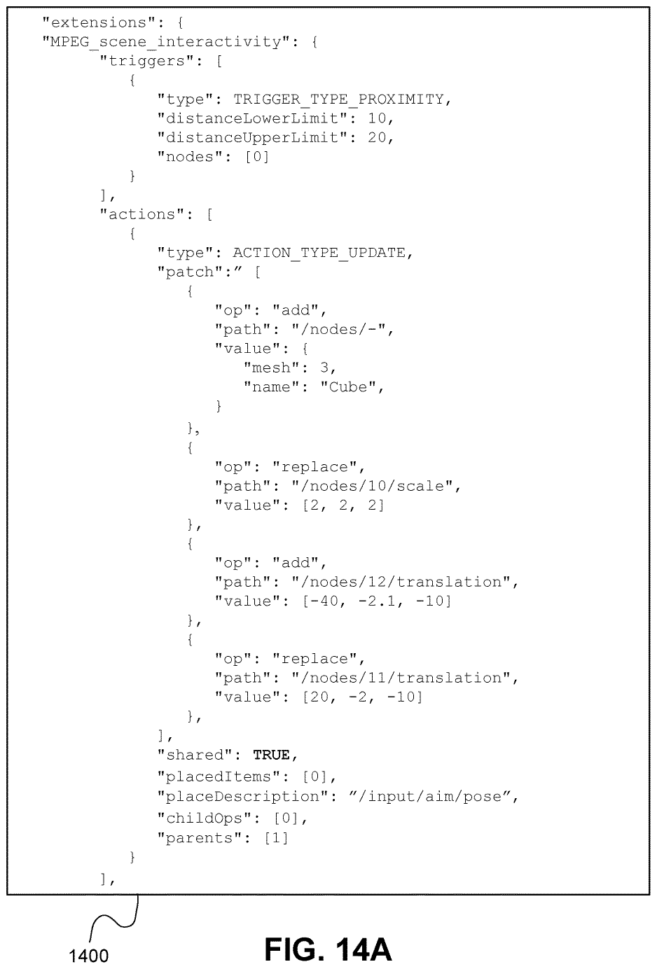

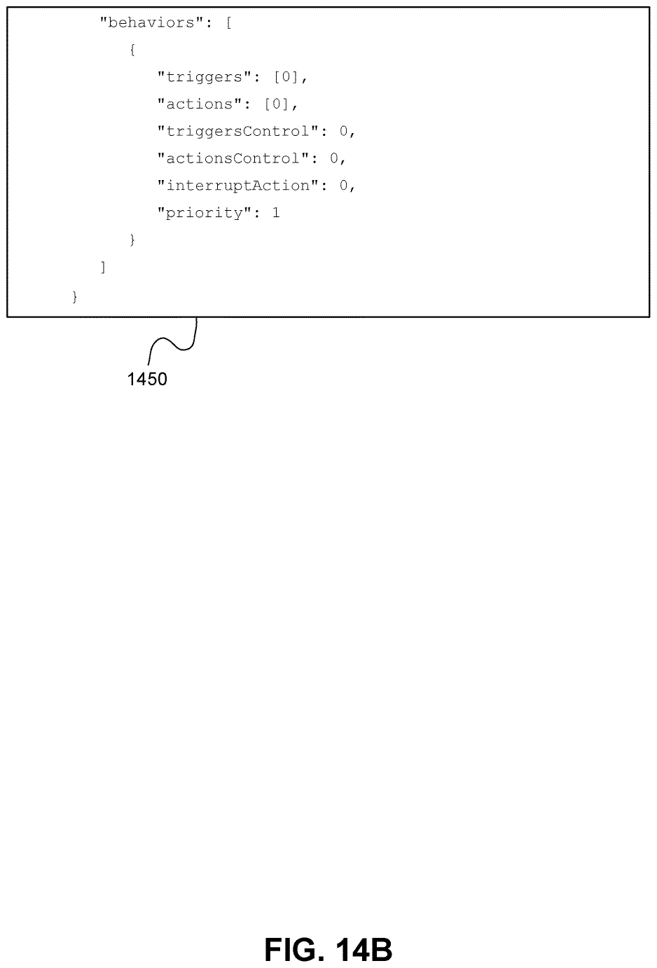

FIGS. 14A-14B form a data structure illustrating an example UPDATE action structure according to some embodiments. FIGS. 14A-14B show, for some embodiments, code listings 1400, 1450 that form an example extract of a (complete) gITF scene description file, and the description of all of the objects contained in a scene are not shown here. For this example, the gITF description contains an array of gITF nodes with at least 13 items (index 0 to 12). FIGS. 14A-14B give an example of this new UPDATE action. For the example of FIGS. 14A-14B, a proximity trigger, which is shown with a type of “TRIGGER_TYPE_PROXIMITY” and has a value of 1, activates an UPDATE action. In FIG. 14A, an UPDATE action has a type of “ACTION_TYPE_UPDATE” and a value of 8. In this example, the patch is an array of 4 operations. The first operation (index 0 of the patch array) adds a new node (a cube) at the end of the gITF nodes array. The second operation (index 1 of the patch array) changes the “scale” element of a first node (index 10 in the gITF nodes array). The third operation (index 2 of the patch array) adds a new “translation” element to a second node (index 12 in the gITF nodes array). The last operation (index 3 of the patch array) changes the “translation” element of a third node (index 11 in the gITF nodes array).

The node referenced by the first operation (index 0 of the patch array) is the last node in gITF nodes array (“/nodes/−”). In this case, the last node that is added to the end of the gITF nodes array is index 13.

The childOps array contains the index “[0]”. As a result, index 0 of the patch array creates a child node. Also, the placedItems array contains the index “[0]”. As a result, the operation for index 0 of the patch array (the first “add” operation) uses the placeDescription string as a value parameter. In this situation, placeDescription has a string value of “/input/aim/pose”. Hence, the node is placed at the position where the user is pointing, which is the position of the user's digit. The parents array contains the index “1”, thus, the node created by the first patch operation (index 0) is created as a child of the node 1. As such, a cube is created as a new child of node 1.

The second operation (index [1] of the patch array) replaces the scale element of node 10. Hence, the scale of node 10 is replaced with the value of [2, 2, 2].

The third operation (index [2] of the patch array) adds a translation to node 12. Hence, a new “translation” element with the value of [−40,−2.1,−10] is added to node 12.

The fourth operation (index [3] of the patch array) replaces the translation of node 11. Hence, the translation of node 11 is replaced with the value of [20,−2,−10].

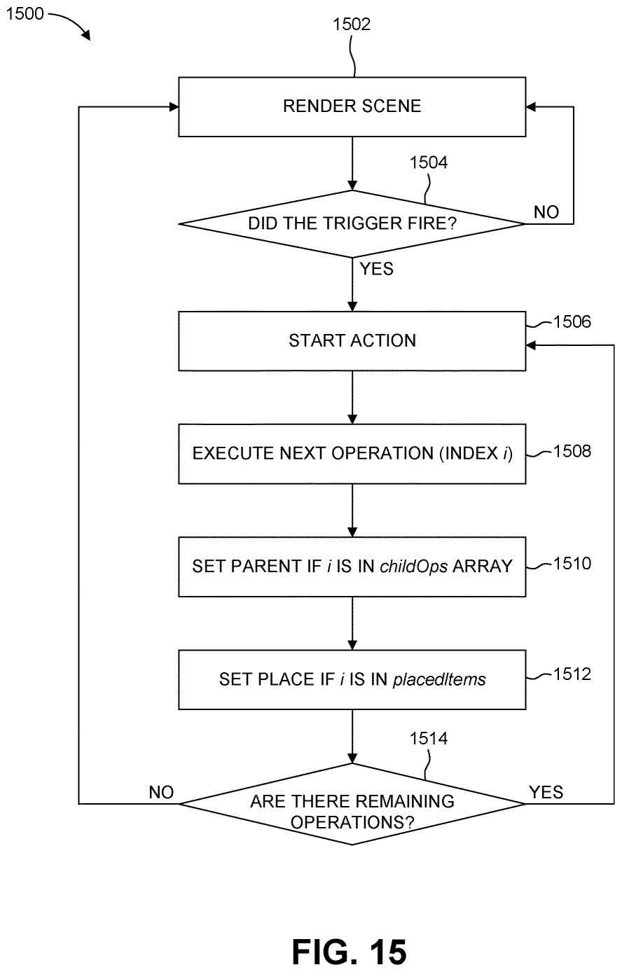

FIG. 15 is a flowchart illustrating an example UPDATE action process according to some embodiments. In the example UPDATE action process 1500, if a trigger is detected 1504 as firing, then flow progresses to the start action box 1506. Otherwise, flow returns to render1502 the scene.

At the start action box 1506, the parameters are checked for validity. The loop index i is initialized to 0. The next operation in the patch array for the index i is executed 1508. If the childOps array contains the current index i in the list of indices, then the node, referenced in the operation is set 1510 as a child of the node specified in the “parents” array. If the placedItems array contains the current index i in the list of indices, then the position of the node, referenced in the operation, is set 1512 according to the placeDescription value.

If there are more operations to perform 1514, then flow returns to the top of the loop to increment the index i. Otherwise, flow returns to render the scene.

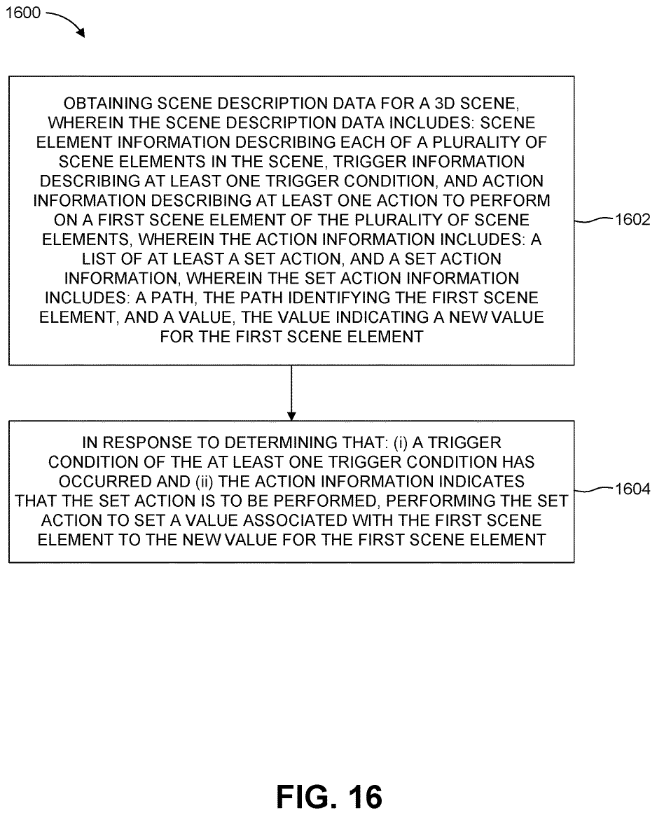

FIG. 16 is a flowchart illustrating an example process for performing a set action according to some embodiments. For some embodiments, an example process 1600 may include obtaining 1602 scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least a set action, and a set action information, wherein the set action information includes: a path, the path identifying the first scene element, and a value, the value indicating a new value for the first scene element. For some embodiments, the example process 1600 may further include: in response to determining 1604 that: (i) a trigger condition of the at least one trigger condition has occurred and (ii) the action information indicates that the set action is to be performed, performing the set action to set a value associated with the first scene element to the new value for the first scene element.

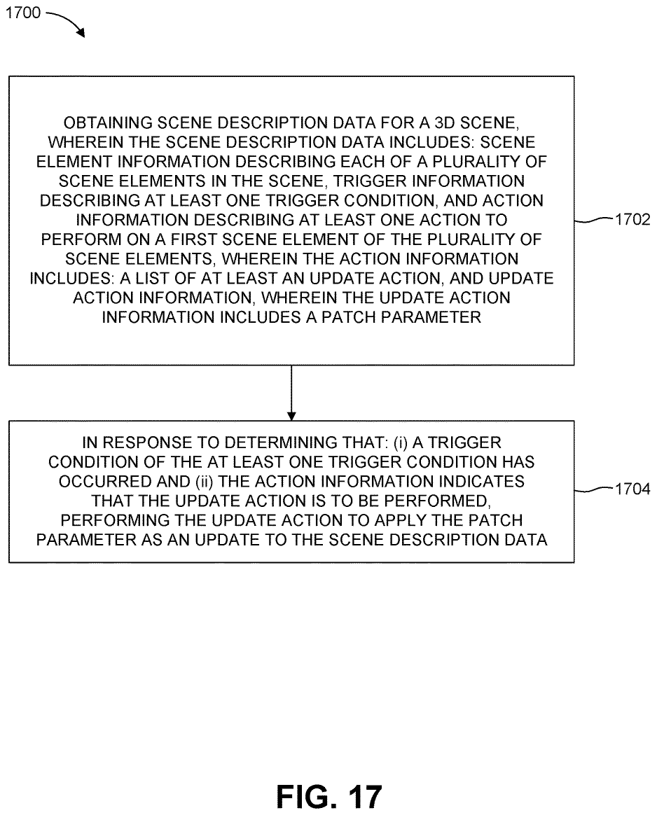

FIG. 17 is a flowchart illustrating an example process for performing an update action according to some embodiments. For some embodiments, an example process 1700 may include obtaining 1702 scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least an update action, and update action information, wherein the update action information includes: a patch parameter. For some embodiments, the example process 1700 may further include: in response to determining 1704 that: (i) a trigger condition of the at least one trigger condition has occurred and (ii) the action information indicates that the update action is to be performed, performing the update action to apply the patch parameter as an update to the scene description data.

While the methods and systems in accordance with some embodiments are discussed in the context of virtual reality (VR), some embodiments may be applied to mixed reality (MR)/augmented reality (AR) contexts as well. Also, although the term “head mounted display (HMD)” is used herein in accordance with some embodiments, some embodiments may be applied to a wearable device (which may or may not be attached to the head) capable of, e.g., VR, AR, and/or MR for some embodiments.

An example method in accordance with some embodiments may include: obtaining scene description data for a three dimensional (3D) scene, wherein the scene description data may include: scene element information describing each of a plurality of scene elements in the scene, trigger information describing at least one trigger condition, and action information describing at least one action to perform on a first scene element of the plurality of scene elements, wherein the action information may include: a list of at least a set action, and a set action information, wherein the set action information may include: a path, the path identifying the first scene element, and a value, the value indicating a new value for the first scene element; and in response to determining that: (i) a trigger condition of the at least one trigger condition has occurred and (ii) the action information indicates that the set action is to be performed, performing a first action, of the at least one action, on the first scene element.

For some embodiments of the example method, determining that the trigger condition has occurred may include a logical determination that the trigger condition has occurred.

For some embodiments of the example method, determining that the trigger condition has occurred may include determining that the trigger condition has produced a true result.

For some embodiments of the example method, the path may identify a location of the first scene element within a scene tree.

For some embodiments of the example method, the first action may include setting a value associated with the first scene element to the new value for the first scene element.

For some embodiments of the example method, setting the value associated with the first scene element sets the value associated with the first scene element to the new value.

For some embodiments of the example method, the set action information may further include a shared field, the shared field indicating a status of sharing with devices connected to the 3D scene.

Some embodiments of the example method may further include: in response to determining that the shared field indicates a true result, performing the first action, of the at least one action, on at least one device sharing the 3D scene.

Some embodiments of the example method may further include: in response to determining that the shared field indicates the true result, performing the first action, of the at least one action, on all devices sharing the 3D scene.

For some embodiments of the example method, the set action information may further include a place description field, and the place description field may identify a source of location information.

For some embodiments of the example method, the first action may include setting a location of the first scene element within the scene, and setting the location of the first scene element may use the location information from the identified source.

For some embodiments of the example method, the path may be a JavaScript Object Notation (JSON) pointer referencing the first scene element.

For some embodiments of the example method, the path may include path information referencing the first scene element, and the path information may correspond to an Internet Engineering Task Force (IETF) standard.

For some embodiments of the example method, the scene description data may further include behavior information.

An example apparatus in accordance with some embodiments may include: a processor; and a non-transitory computer-readable medium storing instructions operative, when executed by the processor, to cause the apparatus to perform the method of any one of the methods listed above.

An additional example method in accordance with some embodiments may include: obtaining scene description data for a 3D scene, wherein the scene description data may include: scene element information describing each of a plurality of scene elements in the scene, trigger information describing at least one trigger condition, and action information describing at least one action to perform on a first scene element of the plurality of scene elements, wherein the action information may include: a list of at least an update action, and an update action information, wherein the update action information may include: a patch parameter; and in response to determining that: (i) a trigger condition of the at least one trigger condition has occurred and (ii) the action information indicates that the update action is to be performed, performing a first action, of the at least one action, on the scene description data.

For some embodiments of the additional example method, determining that the trigger condition has occurred may include a logical determination that the trigger condition has occurred.

For some embodiments of the additional example method, determining that the trigger condition has occurred may include determining that the trigger condition has produced a true result.

For some embodiments of the additional example method, the first action may include applying an update to the scene description data.

For some embodiments of the additional example method, the patch parameter may indicate one or more operations comprising one of more of add, remove, replace, move, and copy, and the one or more operations may be applied to a JavaScript Object Notation (JSON) element of the scene description data.

For some embodiments of the additional example method, each of the one or more operations may include a set of operation parameters, and each set of operation parameters may include: an operation identifier, a path to a JavaScript Object Notation (JSON) element of the scene description data, and a value to apply.

For some embodiments of the additional example method, the path may be a JSON pointer referencing the first scene element.

For some embodiments of the additional example method, each of the one or more operations may include a set of operation parameters, and each set of operation parameters may include: an operation identifier, a path to a JavaScript Object Notation (JSON) element, and a source JSON element.

For some embodiments of the additional example method, the path may be a JSON pointer referencing the first scene element.

For some embodiments of the additional example method, the patch parameter may indicate a JavaScript Object Notation (JSON) patch to apply to the scene description data.

For some embodiments of the additional example method, the patch parameter may include a location pointer to a JavaScript Object Notation (JSON) file including a JSON patch to apply to the scene description data.

For some embodiments of the additional example method, the update action information may further include a shared field, the shared field indicating a status of sharing with devices connected to the 3D scene.

Some embodiments of the additional example method may further include: in response to determining that the shared field indicates a true result, performing the first action, of the at least one action, on at least one device sharing the 3D scene.

Some embodiments of the additional example method may further include: in response to determining that the shared field indicates the true result, performing the first action, of the at least one action, on all devices sharing the 3D scene.

For some embodiments of the additional example method, the update action information may further include a place description field and a placedItems field, the place description field may identify a source of location information, and the placedItems field may identify a patch operation to use.

For some embodiments of the additional example method, the first action may include setting a location of the first scene element within the scene, and setting the location of the first scene element may use the location information from the identified source.

For some embodiments of the additional example method, the update action information may further include: a childOps array, the childOps array indicating patch operations that reference a node that is to be set as a child of an existing node in the scene description data; and a parents array, the parents array indicating nodes of where to add each new child referenced in the patch operations from the childOps array.

For some embodiments of the additional example method, the scene description data may further include behavior information.

An additional example apparatus in accordance with some embodiments may include: a processor; and a non-transitory computer-readable medium storing instructions operative, when executed by the processor, to cause the apparatus to perform the method of any one of the methods listed above.

Another example method in accordance with some embodiments may include: obtaining scene description data for a 3D scene, wherein the scene description data may include: scene element information describing each of a plurality of scene elements in the scene, trigger information describing at least one trigger condition, and action information describing at least one action to perform on a first scene element of the plurality of scene elements, wherein the action information may include: a list of at least a set action, and a set action information, wherein the set action information may include: a path, the path identifying the first scene element, and a value, the value indicating a new value for the first scene element; and in response to triggering execution of the set action, performing a first action, of the at least one action, on the first scene element.

Another example apparatus in accordance with some embodiments may include: a processor; and a non-transitory computer-readable medium storing instructions operative, when executed by the processor, to cause the apparatus to perform the method listed above.

A further example method in accordance with some embodiments may include: obtaining scene description data for a 3D scene, wherein the scene description data may include: scene element information describing each of a plurality of scene elements in the scene, trigger information describing at least one trigger condition, and action information describing at least one action to perform on a first scene element of the plurality of scene elements, wherein the action information may include: a list of at least an update action, and an update action information, wherein the update action information may include: a scene description patch; and in response to triggering execution of the update action, performing a first action, of the at least one action, on the scene description data.

A further example apparatus in accordance with some embodiments may include: a processor; and a non-transitory computer-readable medium storing instructions operative, when executed by the processor, to cause the apparatus to perform the method listed above.

A first example method in accordance with some embodiments may include: obtaining scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least an update action, and update action information, wherein the update action information includes: a patch parameter; and in response to determining that: (i) a trigger condition of the at least one trigger condition has occurred and (ii) the action information indicates that the update action is to be performed, performing the update action to apply the patch parameter as an update to the scene description data.

For some embodiments of the first example method, determining that the trigger condition has occurred comprises a logical determination that the trigger condition has occurred.

For some embodiments of the first example method, determining that the trigger condition has occurred comprises determining that the trigger condition has produced a true result.

For some embodiments of the first example method, the patch parameter indicates one or more operations comprising one or more of add, remove, replace, move, and copy, and the one or more operations are applied to a JavaScript Object Notation (JSON) element of the scene description data.

For some embodiments of the first example method, the update action information further comprises a shared field, the shared field indicating a status of sharing with devices connected to the 3D scene.

Some embodiments of the first example method may further include in response to determining that the shared field indicates a true result, performing the update action on at least one device sharing the 3D scene.

Some embodiments of the first example method may further include in response to determining that the shared field indicates the true result, performing the update action on all devices sharing the 3D scene.

For some embodiments of the first example method, the update action information further comprises a place description field and a placedItems field, the place description field identifies a source of location information, the placedItems field is an array, and the placedlems array indicates patch operations that reference nodes to be placed at a given location.

For some embodiments of the first example method, the update action comprises setting a location of at least a scene element within the scene, and the at least scene element of the scene is referenced in the at least path operations from the placedItems field, and setting the location of the at least scene element uses the location information from the identified source.

For some embodiments of the first example method, the update action information further includes: a childOps array, the childOps array indicating patch operations that reference a node that is to be set as a child of an existing node in the scene description data; and a parents array, the parents array indicating nodes of where to add each new child referenced in the patch operations from the childOps array.

For some embodiments of the first example method, the scene description data further comprises behavior information.

For some embodiments of the first example method, each of the one or more operations comprises a set of operation parameters, and each set of operation parameters includes: an operation identifier, a path to a JavaScript Object Notation (JSON) element of the scene description data, and a value to apply.

For some embodiments of the first example method, the path is a JSON pointer referencing the first scene element.

For some embodiments of the first example method, each of the one or more operations comprises a set of operation parameters, and each set of operation parameters includes: an operation identifier, a path to a JavaScript Object Notation (JSON) element, and a source JSON element.

For some embodiments of the first example method, the path is a JSON pointer referencing the first scene element.

For some embodiments of the first example method, the patch parameter indicates a JavaScript Object Notation (JSON) patch to apply to the scene description data.

For some embodiments of the first example method, the patch parameter includes a location pointer to a JavaScript Object Notation (JSON) file comprising a JSON patch to apply to the scene description data.

A first example apparatus in accordance with some embodiments may include: a processor; and a non-transitory computer-readable medium storing instructions operative, when executed by the processor, to cause the apparatus to perform any one of the methods listed above.

A second example method in accordance with some embodiments may include: obtaining scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least a set action, and a set action information, wherein the set action information includes: a path, the path identifying the first scene element, and a value, the value indicating a new value for the first scene element; and in response to determining that: (i) a trigger condition of the at least one trigger condition has occurred and (ii) the action information indicates that the set action is to be performed, performing the set action to set a value associated with the first scene element to the new value for the first scene element.

For some embodiments of the second example method, determining that the trigger condition has occurred comprises a logical determination that the trigger condition has occurred.

For some embodiments of the second example method, determining that the trigger condition has occurred comprises determining that the trigger condition has produced a true result.

For some embodiments of the second example method, the path identifies a location of the first scene element within a scene tree.

For some embodiments of the second example method, setting the value associated with the first scene element sets the value associated with the first scene element to the new value.

For some embodiments of the second example method, the set action information further includes a shared field, the shared field indicating a status of sharing with devices connected to the 3D scene.

Some embodiments of the second example method may further include in response to determining that the shared field indicates a true result, performing the set action, of the at least one action, on at least one device sharing the 3D scene.

Some embodiments of the second example method may further include in response to determining that the shared field indicates the true result, performing the set action, of the at least one action, on all devices sharing the 3D scene.

For some embodiments of the second example method, the set action information further comprises a place description field, and the place description field identifies a source of location information.

For some embodiments of the second example method, the set action includes setting a location of the first scene element within the scene, and setting the location of the first scene element uses the location information from the identified source.

For some embodiments of the second example method, the path is a JavaScript Object Notation (JSON) pointer referencing the first scene element.

For some embodiments of the second example method, the path includes path information referencing the first scene element, and the path information corresponds to an Internet Engineering Task Force (IETF) standard.

For some embodiments of the second example method, the scene description data further includes behavior information.

A second example apparatus in accordance with some embodiments may include: a processor; and a non-transitory computer-readable medium storing instructions operative, when executed by the processor, to cause the apparatus to perform any one of the methods listed above.

A third example method in accordance with some embodiments may include: obtaining scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least an update action, and an update action information, wherein the update action information includes: a scene description patch; and in response to triggering execution of the update action, performing a first action, of the at least one action, on the scene description data.

A third example apparatus in accordance with some embodiments may include: a processor; and a non-transitory computer-readable medium storing instructions operative, when executed by the processor, to cause the apparatus to perform any one of the methods listed above.

A fourth example method in accordance with some embodiments may include: obtaining scene description data for a 3D scene, wherein the scene description data includes: scene element information describing each of a plurality of scene elements in the scene, trigger information describing at least one trigger condition, and action information describing at least one action to perform on a first scene element of the plurality of scene elements, wherein the action information includes: a list of at least a set action, and a set action information, wherein the set action information includes: a path, the path identifying the first scene element, and a value, the value indicating a new value for the first scene element; and in response to triggering execution of the set action, performing a first action, of the at least one action, on the first scene element.

A fourth example apparatus in accordance with some embodiments may include: a processor; and a non-transitory computer-readable medium storing instructions operative, when executed by the processor, to cause the apparatus to perform any one of the methods listed above.

A fifth example apparatus in accordance with some embodiments may include at least one processor configured to perform any one of the methods listed above.

A sixth example apparatus in accordance with some embodiments may include a computer-readable medium storing instructions for causing one or more processors to perform any one of the methods listed above.

A seventh example apparatus in accordance with some embodiments may include at least one processor and at least one non-transitory computer-readable medium storing instructions for causing the at least one processor to perform any one of the methods listed above.

An example signal in accordance with some embodiments may include: a scene description file generated according to any one of the methods listed above.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
A bitstream or signal that includes one or more of the described syntax elements, or variations thereof.
A bitstream or signal that includes syntax conveying information generated according to any of the embodiments described.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining scene description data for a three-dimensional (3D) scene,
wherein the scene description data comprises:
scene element information describing each of a plurality of scene elements in the scene,
trigger information describing at least one trigger condition, and
action information describing at least one action to perform on a first scene element of the plurality of scene elements,
wherein the action information comprises:
a list of at least an update action, and
update action information,
wherein the update action information comprises:
a patch parameter; and
in response to determining that: (i) a trigger condition of the at least one trigger condition has occurred and (ii) the action information indicates that the update action is to be performed, performing the update action to apply the patch parameter as an update to the scene description data.

2. The method of claim 1, wherein determining that the trigger condition has occurred comprises a logical determination that the trigger condition has occurred.

3. The method of claim 1, wherein determining that the trigger condition has occurred comprises determining that the trigger condition has produced a true result.

4. The method of claim 1,
wherein the patch parameter indicates one or more operations comprising one or more of add, remove, replace, move, and copy, and
wherein the one or more operations are applied to a JavaScript Object Notation (JSON) element of the scene description data.

5. The method of claim 1, wherein the update action information further comprises a shared field, the shared field indicating a status of sharing with devices connected to the 3D scene.

6. The method of claim 5, further comprising:
in response to determining that the shared field indicates a true result, performing the update action on at least one device sharing the 3D scene.

7. The method of claim 5, further comprising:
in response to determining that the shared field indicates the true result, performing the update action on all devices sharing the 3D scene.

8. The method of claim 1,
wherein the update action information further comprises a place description field and a placedItems field,
wherein the place description field identifies a source of location information,
wherein the placedItems field is an array, and
wherein the placedIems array indicates patch operations that reference nodes to be placed at a given location.

9. The method of claim 8,
wherein the update action comprises setting a location of at least a scene element within the scene, and
wherein the at least scene element of the scene is referenced in the at least path operations from the placedItems field, and
wherein setting the location of the at least scene element uses the location information from the identified source.

10. The method of claim 1, wherein the update action information further comprises:
a childOps array, the childOps array indicating patch operations that reference a node that is to be set as a child of an existing node in the scene description data; and
a parents array, the parents array indicating nodes of where to add each new child referenced in the patch operations from the childOps array.

11. The method of claim 1, wherein the scene description data further comprises behavior information.

12. The method of claim 1,
wherein each of the one or more operations comprises a set of operation parameters, and
wherein each set of operation parameters comprises:
an operation identifier,
a path to a JavaScript Object Notation (JSON) element of the scene description data, and
a value to apply.

13. The method of claim 12, wherein the path is a JSON pointer referencing the first scene element.

14. The method of claim 1,
wherein each of the one or more operations comprises a set of operation parameters, and
wherein each set of operation parameters comprises:
an operation identifier,
a path to a JavaScript Object Notation (JSON) element, and
a source JSON element.

15. The method of claim 14, wherein the path is a JSON pointer referencing the first scene element.

16. The method of claim 1, wherein the patch parameter indicates a JavaScript Object Notation (JSON) patch to apply to the scene description data.

17. The method of claim 1, wherein the patch parameter comprises a location pointer to a JavaScript Object Notation (JSON) file comprising a JSON patch to apply to the scene description data.

18. An apparatus comprising:
a processor; and
a non-transitory computer-readable medium storing instructions operative, when executed by the processor, to cause the apparatus to:
obtain scene description data for a three-dimensional (3D) scene,
wherein the scene description data comprises:
scene element information describing each of a plurality of scene elements in the scene,
trigger information describing at least one trigger condition, and
action information describing at least one action to perform on a first scene element of the plurality of scene elements,
wherein the action information comprises:
a list of at least an update action, and
update action information,
wherein the update action information comprises:
a patch parameter; and
in response to determining that: (i) a trigger condition of the at least one trigger condition has occurred and (ii) the action information indicates that the update action is to be performed, perform the update action to apply the patch parameter as an update to the scene description data.

19. A method comprising:
obtaining scene description data for a three-dimension (3D) scene,
wherein the scene description data comprises:
scene element information describing each of a plurality of scene elements in the scene,
trigger information describing at least one trigger condition, and
action information describing at least one action to perform on a first scene element of the plurality of scene elements,
wherein the action information comprises:
a list of at least a set action, and
a set action information,
wherein the set action information comprises:
a path, the path identifying the first scene element, and
a value, the value indicating a new value for the first scene element; and
in response to determining that: (i) a trigger condition of the at least one trigger condition has occurred and (ii) the action information indicates that the set action is to be performed, performing the set action to set a value associated with the first scene element to the new value for the first scene element.

20-24. (canceled)

25. The method of claim 19, further comprising:
in response to determining that the shared field indicates a true result, performing the set action, of the at least one action, on at least one device sharing the 3D scene.

26-40. (canceled)
